(19) United States
(12) Patent Application Publication
(10) Pub. No.: US 2007/0258137 A1
(43) Pub. Date: Nov. 8, 2007

(54) Electrooptic Device, Electrooptic-Device Substrate, Method for Manufacturing Electrooptic Device, and Projector

(75) Inventor: Shunji Kamijima, Hara-Mura (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/741,833

(22) Filed: Apr. 30, 2007

(30) Foreign Application Priority Data
May 8, 2006 (JP) 2006-128950

(51) Int. Cl. G02B 27/02

(52) U.S. Cl. 359/431

(57) ABSTRACT

An electrooptic device includes an electrooptic layer and a condensing substrate. The condensing substrate lets the light incident on the condensing substrate into the electrooptic layer. The condensing substrate includes a base and prisms. The prisms are disposed along the boundary region of a plurality of pixel regions. The prisms have a refraction index different from that of the base. At least a portion of the prisms is located within the base.

### CROSS-REFERENCE TO RELATED APPLICATION

This application claims priority from Japanese Patent Application No. 2006-128950 filed in the Japanese Patent Office on May 8, 2006, the entire disclosure of which is hereby incorporated by reference in its entirety.

### BACKGROUND

1. Technical Field

Embodiments of the present invention relate to an electrooptic device for use as the light valve of a projector, an electrooptic-device substrate, a method for manufacturing the electrooptic device, and a projector.

2. Related Art

The image display region of an electrooptic device for use as the light valve of a projector includes a pixel region that emits light and a pixel-region boundary region on which wires for supplying electric signals to the pixel region are formed. For example, liquid crystal devices are constructed such that the boundary region is covered with a light-shielding layer so that no light is allowed to pass through.

Such electrooptic devices are required to emit light from the pixel region as much as possible and as light as possible, and therefore to achieve high light utilization.

Thus, a liquid crystal device is proposed which is provided with an optical element that has a wedge-shaped groove along the boundary region of pixel regions (for example, JP-A-3-170911) The optical element is disposed at one of a pair of opposing substrates of the liquid crystal device. The light passing through the boundary region of the pixel regions is reflected by the groove toward the pixel regions. In other words, the groove functions as a prism owing to the difference between the refraction of the groove and the refraction of the substrate. This allows reduction of light to be interrupted by the light-shielding layer to improve light utilization. Here the groove agrees with the light-shielding layer because it is provided along the boundary region of the pixel regions. Therefore, cover glass is bonded to the surface of the substrate having the groove to form a light-shielding layer on the cover glass.

However, the related-art liquid crystal device also has the following problems: the related-art liquid crystal device has a light-shielding layer on the cover glass, and it is therefore necessary that the substrate having the groove and the cover glass having the light-shielding layer are bonded together with high accuracy. Accordingly, it is desired to manufacture liquid crystal devices easily.

### SUMMARY

Some exemplary embodiments include an electrooptic device that can easily be manufactured, an electrooptic-device substrate, a method for manufacturing the electrooptic device, and a projector.

According to a first exemplary embodiment, there is provided an electrooptic device including: an electrooptic layer; and a condensing substrate. The condensing substrate lets the light incident on the condensing substrate into the electrooptic layer. The condensing substrate includes a base and prisms. The prisms are disposed along the boundary region of a plurality of pixel regions. The prisms have a refraction index different from that of the base. At least one of the elements contained in the prisms is included also in the base.

According to a second exemplary embodiment, there is provided an electrooptic device including an electrooptic layer, a condensing substrate, and a plurality of pixel electrodes. The condensing substrate lets the light incident on the condensing substrate into the electrooptic layer. The condensing substrate includes a base and prisms having a refraction index different from that of the base. The prisms are disposed in such a manner as to agree with the region between each of the pixel electrodes and a pixel electrode adjacent thereto. At least one of the elements contained in the prisms is included also in the base.

According to a third exemplary embodiment, there is provided an electrooptic device including a first substrate, a second substrate, an electrooptic layer disposed between the first substrate and the second substrate, and a condensing substrate disposed between the first substrate and the electrooptic layer. The condensing substrate includes a base and prisms. The light that enters from the first substrate into the region enclosed by the prisms of the base is condensed at the side of the condensing substrate adjacent to the electrooptic layer or to the second substrate. At least one of the elements contained in the prisms is included also in the base.

With the structures, the prisms and the base can be integrated.

Specifically, a change in the arrangement of the molecules forms regions with different refraction indexes even if they are made of the same material. Therefore, light that has entered the base and advances to the prisms is reflected to the pixel regions by the interface between the base and the prisms because the refraction index of the prisms is different from that of the base. This integration simplifies the process of manufacturing the electrooptic device.

In this case, it is preferable that the condensing substrate be made of an inorganic material. The use of the inorganic material for the condensing substrate prevents the degradation of the base and the prisms even if they absorb applied light to generate high temperature. Thus improves the reliability and life of the condensing substrate.

It is preferable that the prisms be formed by modifying part of the precursor of the base.

It is preferable that the prisms and the base have the same composition.

In this case, the refraction indices of part of the base and the other part are made different by modification of part of the base such as a change in the arrangement of the molecules.

It is preferable that the surface of the condensing substrate has a light-shielding layer along the boundary region of the pixel regions.

In this case, the formation of the light-shielding layer on the end faces of the prisms adjacent to the electrooptic layer prevents the light from exiting from the condensing substrate to the boundary region of the pixel regions. Specifically speaking, the light incident on the prisms sometimes enters the boundary region of the pixel regions from the end faces of the prisms adjacent to the electrooptic layer after entering the prisms. The light-shielding layer formed on the end faces of the prisms adjacent to the electrooptic layer interrupts the light exiting from the prisms. This prevents the malfunction of elements at the boundary region of the pixel regions.

Since the prisms and the base are integrated, there is no need to dispose cover glass or the like between the condensing substrate and the light-shielding layer, thus providing a high-accuracy light-shielding layer.

It is preferable that the surface of the prism adjacent to the electrooptic layer have a recess and that the recess have the light-shielding layer.

The forming of the light-shielding layer in the recess increases the flatness of the light-shielding layer and the condensing substrate. This prevents the light exiting from the vicinity of the rim of the prisms or the no-prism region of the condensing substrate from being interrupted by the light-shielding layer.

It is preferable that the condensing substrate have thereon one of a pair of electrodes for driving the electrooptic layer.

The forming of the electrode on the surface of the condensing substrate allows a thin electrooptic device. Moreover, this reduces the distance between the exiting side of the condensing substrate and the liquid-crystal layer in comparison with interposing another substrate between the electrode and the condensing substrate, thus ensuring that light exits from the condensing substrate toward the pixel regions.

In this case, the end faces of the prisms and the end face of the base adjacent to the electrooptic layer may be flush with one another.

This allows the light exiting from the no-prism region of the condensing substrate in the vicinity of the rims of the prisms to enter the pixel regions with more reliability.

According to a fourth exemplary embodiment, there is provided an electrooptic-device substrate that condenses light to a plurality of pixel regions of an electrooptic device. The substrate includes a base and prisms formed along the boundary region of the pixel regions and reflecting incident light toward the plurality of pixel regions arrayed in a plane. The prisms are made of the same material as that of the base.

In this case, the prisms and the base can be integrated, as in the above. Therefore, the electrooptic-device substrate can be formed easily at low cost.

According to a fifth exemplary embodiment, there is provided a method for manufacturing an electrooptic device including an electrooptic layer and a condensing substrate disposed close to the incident side with respect to the electrooptic layer, the condensing substrate reflecting incident light to a plurality of pixel regions arrayed in a plane to let the light into the electrooptic layer. The method includes: modifying part of the base to form prisms with a refraction index different from that of the base, thereby forming the condensing substrate; and disposing the condensing substrate close to the incident side with respect to the electrooptic layer so that the prisms correspond to the boundary region, i.e., regions between the pixel regions.

In this case, the prisms and the base can be integrally formed of the same material, as in the above. Therefore, the condensing substrate can be formed easily at low cost.

Specifically, the forming of prisms by modification reduces the time to manufacture the condensing substrate as compared with forming the prisms by grooving the base, for example.

Therefore, the electrooptic device can be formed easily at low cost.

It is preferable for manufacturing the electrooptic device that the modification of part of the base is melting the base then cooling it.

In this case, the prism region of the base is melted and then cooled. This changes the arrangement of the molecules of the prisms, thereby changing the refraction index of the prisms from that of the base.

In manufacturing the electrooptic device, the modification of part of the base may be applying a laser beam to the base.

In this case, the prisms are formed in such a manner that a laser beam or energy is applied to the base to melt the irradiated portion and then the irradiated portion is cooled for modification. The use of the laser beam allows accurate irradiation of the base.

According to a sixth exemplary embodiment, there is provided a projector including the above-described electrooptic device.

With this electrooptic device, the condensing substrate can be formed easily at low cost, as in the above.

### BRIEF DESCRIPTION OF THE DRAWINGS

Exemplary embodiments of the invention will be described with reference to the accompanying drawings, wherein like numbers reference like elements.

FIG. 1 is a schematic diagram of the projector according to a first embodiment of the invention.

FIG. 2 is a plan view of the liquid crystal panel of FIG. 1.

FIG. 3 is a partial perspective view of the liquid crystal panel of FIG. 2.

FIG. 4 is a partial cross-sectional view of the liquid crystal panel of FIG. 2.

FIG. 5 is a perspective view of a condenser system in the process of modifying the liquid crystal panel of FIG. 2.

FIG. 6A is a cross-sectional view of the liquid crystal panel of FIG. 2, showing a process of manufacture.

FIG. 6B is a cross-sectional view of the liquid crystal panel of FIG. 2, showing a process of manufacture.

FIG. 6C is a cross-sectional view of the liquid crystal panel of FIG. 23 showing a process of manufacture.

FIG. 6D is a cross-sectional view of the liquid crystal panel of FIG. 2, showing a process of manufacture.

FIG. 7 is a diagram describing the operation of the liquid crystal panel of FIG. 2.

FIG. 8A is a cross-sectional view of the liquid crystal panel of FIG. 2, showing another process of manufacture.

FIG. 8B is a cross-sectional view of the liquid crystal panel of FIG. 2, showing another process of manufacture.

FIG. 9 is a cross-sectional view of an opposing substrate according to a second embodiment of the invention.

FIG. 10A is a cross-sectional view of a prism of another shape to which the invention can be applied.

FIG. 10B is a cross-sectional view of a prism of another shape to which the invention can be applied.

FIG. 10C is a cross-sectional view of a prism of another shape to which the invention can be applied.

FIG. 10D is a cross-sectional view of a prism of another shape to which the invention can be applied.

FIG. 11A is a cross-sectional view of a prism of another shape to which the invention can be applied.

FIG. 11B is a cross-sectional view of a prism of another shape to which the invention can be applied.

FIG. 11C is a cross-sectional view of a prism of another shape to which the invention can be applied.

FIG. 11D is a cross-sectional view of a prism of another shape to which the invention can be applied.

FIG. 12A is a cross-sectional view of a prism of another shape to which the invention can be applied.

FIG. 12B is a cross-sectional view of a prism of another shape to which the invention can be applied.

FIG. 12C is a cross-sectional view of a prism of another shape to which the invention can be applied.

FIG. 12D is a cross-sectional view of a prism of another shape to which the invention can be applied.

FIG. 13A is a cross-sectional view of a prism of another shape to which the invention can be applied.

FIG. 13B is a cross-sectional view of a prism of another shape to which the invention can be applied.

FIG. 13C is a cross-sectional view of a prism of another shape to which the invention can be applied.

### DESCRIPTION OF EXEMPLARY EMBODIMENTS

### First Embodiment

An electrooptic device and a projector according to a first embodiment of the invention will be described with reference to the drawings.

### Projector

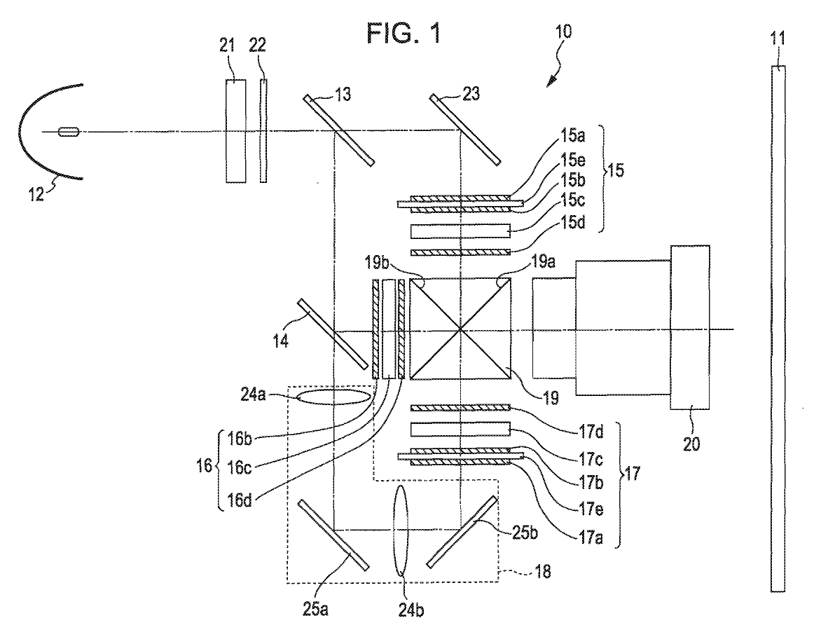

First, a projector according to the embodiment will be described. FIG. 1 is a schematic diagram of the projector, denoted by numeral 10. As shown in FIG. 1, the projector 10 is a projection display system that emits light onto a screen 11 on the viewer side so that the viewer can view the light reflected by the screen 11. The projector 10 includes a light source 12, dichroic mirrors 13 and 14, spatial light modulators (liquid crystal devices) 15 to 17, an optical waveguide 18, a cross dichroic prism 19, and a projection system 20.

The light source 12 is constructed of an ultra-high-pressure mercury lamp that emits light including red light, green light, and blue light.

The dichroic mirror 13 transmits red light and reflects green light and blue light emitted from the light source 12. The dichroic mirror 14 transmits the blue light and reflects the green light of the green light and the blue light reflected by the dichroic mirror 13. Thus, the dichroic mirrors 13 and 14 constitute a color separation system that separates the light emitted from the light source 12 into red light, green light, and blue light.

An integrator 21 and a polarization conversion element 22 are disposed between the dichroic mirror 13 and the light source 12 in that order from the light source 12. The integrator 21 uniformizes the illuminance distribution of the light from the light source 12. The polarization conversion element 22 polarizes the light from the light source 12 into polarized light that oscillates in a specified direction, such as s-polarized light.

The spatial light modulator 15 is a transmissive liquid crystal device that modulates red light that has passed through the dichroic mirror 13 and reflected by a reflection mirror 23 in accordance with an image signal. The spatial light modulator 15 includes a λ/2-retarder 15a, a first polarizer 15b, a liquid crystal panel (electrooptic panel) 15c, and a second polarizer 15d. The red light incident on the spatial light modulator 15 remains as s-polarized light because its polarization does not change even through the dichroic mirror 13.

The λ/2-retarder 15a is an optical element that converts the s-polarized light incident on the spatial light modulator 15 to p-polarized light. The first polarizer 15b is a polarizer that interrupts s-polarized light and transmits p-polarized light. The liquid crystal panel 15c converts p-polarized light to s-polarized light by modulation according to an image signal. The second polarizer 15d is a polarizer that interrupts p-polarized light and transmits s-polarized light. The spatial light modulator 15 thus modulates red light according to an image signal and lets out s-polarized red light to the cross dichroic prism 19.

The λ/2-retarder 15a and the first polarizer 15b are disposed in contact with a light-transmissive glass plate 15e that does not convert polarization. This prevents the thermal distortion of the λ/2-retarder 15a and the first polarizer 15b.

A spatial light modulator 16 is a transmissive liquid crystal device that modulates green light that has been reflected by the dichroic mirror 13 and then reflected by the dichroic mirror 14 in accordance with an image signal. The spatial light modulator 16 includes, like the spatial light modulator 15, a first polarizer 16b, a liquid crystal panel (electrooptic panel) 16c, and a second polarizer 16d. The green light incident on the spatial light modulator 16 is s-polarized light because it is reflected by the dichroic mirrors 13 and 14.

The first polarizer 16b is a polarizer that interrupts p-polarized light and transmits s-polarized light. The liquid crystal panel 16c converts s-polarized light to p-polarized light by modulation according to an image signal. The second polarizer 16d is a polarizer that interrupts s-polarized light and transmits p-polarized light. The spatial light modulator 16 thus modulates green light according to an image signal and lets out p-polarized green light to the cross dichroic prism 19.

A spatial light modulator 17 is a transmissive liquid crystal device that modulates blue light that has been reflected by the dichroic mirror 13 and then passed through the dichroic mirror 14 and the optical waveguide 18 in accordance with an image signal. The spatial light modulator 17 includes, like the spatial light modulators 15 and 16, a λ/2-retarder 17a, a first polarizer 17b, a liquid crystal panel (electrooptic panel) 17e, and a second polarizer 17d. Blue light incident on the spatial light modulator 17 is s-polarized light because it is reflected by the dichroic mirror 13, passes through the dichroic mirror 14, and is then reflected by two reflection mirrors 25a and 25b, to be described later, of the optical waveguide 18.

The λ/2-retarder 17a is an optical element that converts the s-polarized light incident on the spatial light modulator 17 to p-polarized light. The first polarizer 17b is a polarizer that interrupts s-polarized light and transmits p-polarized light. The liquid crystal panel 17c converts p-polarized light to s-polarized light by modulation according to an image signal. The second polarizer 17d is a polarizer that interrupts p-polarized light and transmits s-polarized light. The spatial light modulator 17 thus modulates blue light according to an image signal and lets out s-polarized blue light to the cross dichroic prism 19.

The λ/2-retarder 17a and the first polarizer 17b are disposed in contact with a glass plate 17e.

The optical waveguide 18 includes relay lenses 24a and 24b and reflection mirrors 25a and 25b.

The relay lenses 34a and 24b are provided to prevent light loss due to the long optical path of blue light. The relay lens 24a is disposed between the dichroic mirror 14 and the reflection mirror 25a. The relay lens 24b is disposed between the reflection mirrors 25a and 25b.

The reflection mirror 25a is disposed so as to reflect the blue light that has passed through the dichroic mirror 14 and has exited the relay lens 24a toward the relay lens 24b. The reflection mirror 25b is disposed so as to reflect the blue light that has exited the relay lens 24b to the spatial light modulator 17.

The cross dichroic prism 19 is a color combining system in which two intersecting dichroic filters 19a and 19b are disposed in X-shape. The dichroic filter 19a reflects blue light and transmits green light. The dichroic filter 19b reflects red light and transmits green light. Thus, the cross dichroic prism 19 combines the red light, green light, and blue light that have modulated by the spatial light modulators 15 to 17, respectively, and let them out toward the projection system 20.

The light exiting from the spatial light modulators 15 and 17 and incident on the cross dichroic prism 19 has become s-polarized light. The light exiting from the spatial light modulator 16 and incident on the cross dichroic prism 19 has become p-polarized light. This difference in polarization of the light incident on the cross dichroic prism 19 allows effective combination of the light exiting from the spatial light modulators 15 and 17. The dichroic filters 19a and 19b generally have a high s-polarized light reflecting characteristic, and therefore the blue light and red light reflected by the dichroic filters 19a and 19b, respectively, are converted to s-polarized light, while the green light to pass through the dichroic filters 19a and 19b is converted to p-polarized light.

The projection system 20 has a projection lens (not shown) for projecting the light combined by the cross dichroic prism 19 onto a screen 11.

### Liquid Crystal Panel

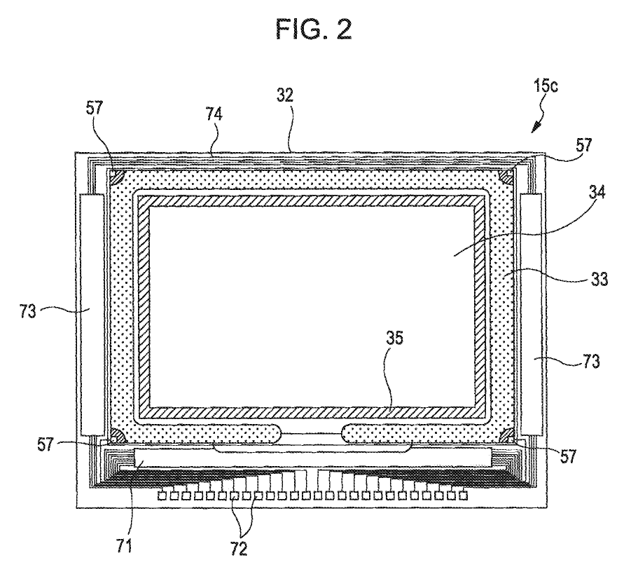

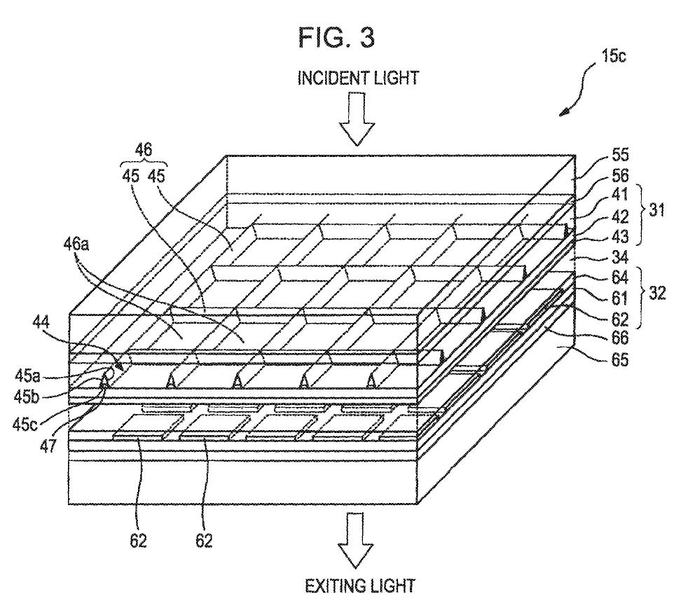

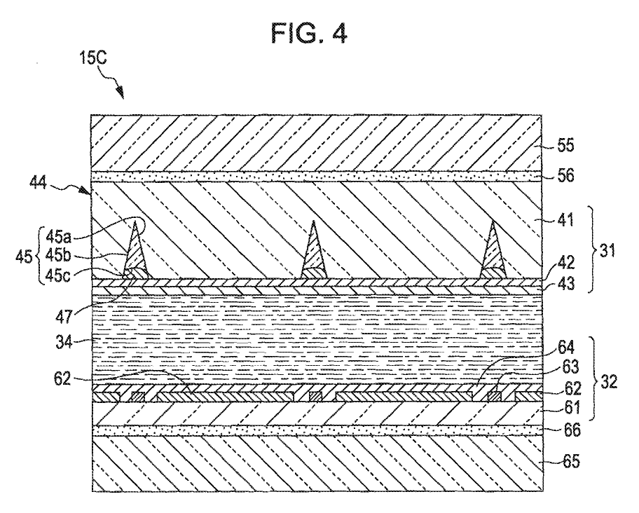

The liquid crystal panels 15c to 11c of an embodiment will be described. The liquid crystal panels 15c to 17c have the same basic configuration only with different wavebands for light to be modulated. Accordingly, the liquid crystal panel 15c will be described as a typical example. FIG. 2 is a general view of the liquid crystal panel 15c; FIG. 3 is a fragmentary perspective view of the liquid crystal panel 15c; FIG. 4 is a cross-sectional view of the liquid crystal panel 15c; and FIG. 5 is a back view of an opposing substrate 31. FIG. 2 shows no opposing substrate.

As shown in FIGS. 2 TO 4, the liquid crystal panel 15c includes an opposing substrate 31 and a TFT substrate (second substrate) 32, which are bonded together with a sealing member 33. The liquid crystal panel 15c also has a liquid-crystal layer (electrooptic layer) 34 enclosed by the TFT substrate 32, the opposing substrate 31, and the sealing member 33. The surface of the liquid crystal panel 15c inside the sealing member 33 is provided with a peripheral light-shielding layer 35 serving as a parting line.

As shown in FIGS. 3 and 4, the opposing substrate 31 includes a condensing substrate 41 and an opposing electrode 42 and an alignment layer 43 which are provided on the surface of the condensing substrate 41 adjacent to the liquid-crystal layer 34.

The condensing substrate 41 is made of a light-transmissive material such as glass. The condensing substrate 41 has a base 44 and a prism group 46 including a plurality of prisms 45 disposed inside the base 44 adjacent to the liquid-crystal layer 34, the prisms 45 being integrated with the base 44.

The condensing substrate 41 may not necessarily be made of glass but may be made of another light-transmissive material such as quartz glass, borosilicate glass, soda lime glass (blue flat glass), or crown glass (white flat glass).

As shown in FIGS. 3 and 4, the prisms 45 are formed in a grid pattern in the position that agrees in plan view with the boundary of the pixel regions partitioned by pixel electrodes (electrodes) 62, to be described later, signal lines (not shown), and scanning lines (not shown) of the condensing substrate 41. In other words, the prisms 45 are disposed in such a manner so as to correspond to the signal lines and the scanning lines in plan view. The regions between the prisms 45, which correspond to the pixel regions in plan view, form openings 46a of the prism group 46.

The prisms 45 are changed in quality from the base 44. In other words, the prisms 45 are made of the same material as that of the base 44 but have a different refractive index from the base 44.

The prisms 45 each have a cross section of substantially an isosceles triangle, and have slopes 45a and 45b. The prisms 45 reflect the light incident on the prisms 45 from the interior of the base 44 toward the pixel regions by the slopes 45a and 45b. The prisms 45 are shaped in a grid pattern so as to correspond to the pixel regions, and thus function as light condenser for improving the efficiency of light utilization by reflecting the incident light from the interior of the base 44 which advances to the boundary region of the pixel regions toward the pixel regions.

Each prism 45 also has a recess 45c at the end face adjacent to the liquid-crystal layer 34. The recess 45c is filled with a light-shielding material to form a light-shielding layer 47. Examples of the light-shielding material are metals such as chromium, aluminum, nickel, and titanium.

The end face of the light-shielding layer 47 adjacent to the liquid-crystal layer 34 and the surface of the base 44 are flush with each other. The condensing substrate 41 functions as a light shield by interrupting the light that enters from the interior of the base 44 into the prisms 45 and exits from the end face of the prisms 45 toward the boundary region of the pixel regions.

The alignment layer 43 is formed by performing specified alignment such as rubbing on a light-transmissive organic film such as a polyimide film,

Dustproof glass (first substrate) 55 is fixed to the surface of the opposing substrate 31 apart from the liquid-crystal layer 34 with an adhesive layer 56. Examples of the adhesive layer 56 are a silicon-based adhesive and an acrylic adhesive which have substantially the same refractivity as those of the condensing substrate 41 and the dustproof glass 55 and which become transparent after hardening.

The portions of the opposing substrate 31 which agree with the corners of the sealing member 33 in plan view each have an inter-substrate conducting member 57 for electrical conduction between the opposing substrate 31 and the TFT substrate 32.

As shown in FIGS. 3 and 4, the TFT substrate 32 includes a substrate main body 61, pixel electrodes 62 formed on the surface of the substrate main body 61 adjacent to the liquid-crystal layer 34, TFT elements 63 for driving the pixel electrodes 62, and an alignment layer 64.

The substrate main body 61 is made of a light-transmissive material such as glass, like the condensing substrate 41.

As shown in FIGS. 3 and 4, the pixel electrodes 62 are disposed in matrix form on the substrate main body 61 in such a manner as to agree with the openings 46a of the prism group 46 and not to agree with the prisms 45 in plan view. In other words, each pixel electrode 62 is disposed so as to agree with the region surrounded by the prisms 45 as viewed in the direction perpendicular to the dustproof glass 55 or in plan view. The pixel electrodes 62 are made of a light-transmissive material such as indium tin oxide (ITO).

The TFT elements 63 are disposed on the substrate main body 61 in such a manner as to correspond to the pixel electrodes 62, respectively, and to agree with the prisms 45 in plan view. The TFT elements 63 are made of an amorphous polysilicon film or a polysilicon film that is a crystallized amorphous polysilicon film which is partially formed on the substrate main body 61.

The alignment layer 64 is formed by applying specified alignment such as rubbing on a light-transmissive organic layer, like the alignment layer 43. The alignment layers 43 and 64 are formed in such a manner that their orientations intersect substantially at right angles.

The surface of the substrate main body 61 inside the sealing member 33 in plan view and adjacent to the liquid crystal layer 34 is provided with signal lines (not shown) and scanning lines (not shown) that connect the pixel electrodes 62 and the TFT elements 63. The signal lines and the scanning lines are disposed in the position corresponding to the prisms 45 in plan view. The pixel region is divided by the TFT elements 63, the signal lines, and the scanning lines to form pixel regions that do not agree with the prisms 45 in plan view and to form the boundary region of the pixel regions that agree with the prisms 45. The pixel regions constitute an image display region.

A dustproof glass 65 is fixed to the surface of the TFT substrate 32 apart from the liquid-crystal layer 34 with an adhesive layer 66. Examples of the adhesive layer 66 are a silicon-based adhesive and an acrylic adhesive which have substantially the same refractivity as those of the substrate main body 61 and the dustproof glass 65 and which become transparent after hardening.

As shown in FIG. 2, the region of the TFT substrate 32 outside the sealing member 33 in plan view has a data-line driving circuit 71 and external-circuit mounting terminals 72 along a first side of the TFT substrate 32. The region of the TFT substrate 32 outside the sealing member 33 also has scanning-line driving circuits 73 along two sides of the TFT substrate 32 adjacent to the first side. The region of the TFT substrate 32 outside the sealing member 33 also has a plurality of wires for connecting the scanning-line driving circuits 73 on both sides of the image display region.

In place of the data-line driving circuit 71 and the scanning-line driving circuits 73 on the TFT substrate 32, for example, a tape automated bonding (TAB) substrate having a driving LSI and the terminals along the periphery of the TFT substrate 32 may be connected together electrically and mechanically via an anisotropic conducting layer.

As shown in FIGS. 2 to 4, the liquid-crystal layer 34 is aligned in a specified orientation between the alignment layers 43 and 64. The mode of the liquid-crystal layer 34 can be any of a twisted nematic (TN) mode, a vertical aligned nematic (VAN) mode, a super twisted nematic (STN) mode, an electrically controlled birefringence (ECB) mode, and an optical compensated bend (OCB) mode.

Method for Manufacturing Liquid Crystal Panel

A method for manufacturing the liquid crystal panel 15c with the above structure will be described.

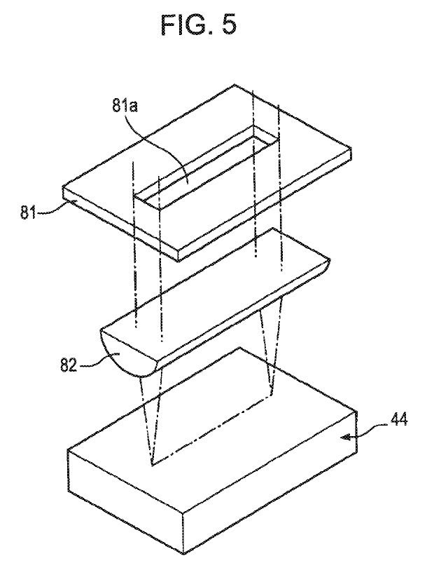

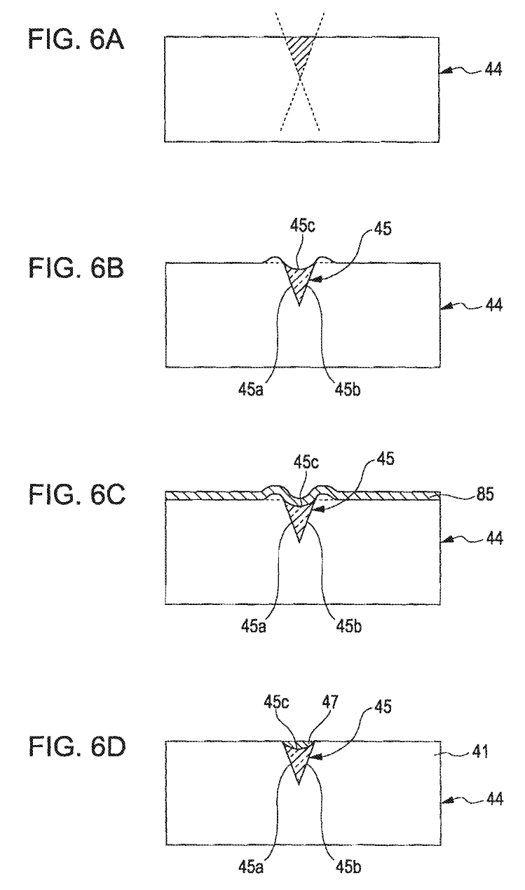

First, part of the base 44 is changed in quality to form the prisms 45. Here the base 44 is irradiated with a laser beam using the condensing system as shown in FIG. 5 (see FIG. 6A). The condensing system is disposed on the base 44 and includes a mask 81 having an opening 81a with a specified shape and a condensing lens 82 disposed between a light source (not shown) and the mask 81. An example of the light source is a high-output yttrium aluminum garnet (YAG) laser which runs at low cost. The opening 81a of the mask 81 has a shape that allows a laser beam to pass through linearly along the region of the prisms 45. For the condensing lens 82 is used a cylindrical lens that linearly condenses the laser beam that has passed through the opening 81a of the mask 8.

When the base 44 is irradiated with a laser beam using the condensing system, the irradiated region of the base 44 (the hatched region in FIG. 6A) absorbs the laser beam to increase in temperature. Pollen the temperature of the irradiated region has exceeded a glass transition temperature of the base 44, the irradiated region of the base 44 melts. Then, the irradiation of the laser beam is terminated to cool the base 44. This melting and cooling of the laser-beam irradiated region changes the orientation of the molecules of the laser-beam irradiated region before and after. In other words, the arrangement of the molecules becomes different between the laser-beam irradiated region and the nonirradiated region of the base 44 and thus the irradiated region is modified. Thus, the refraction index of the base 44 becomes different between the irradiated region and the nonirradiated region. If glass is used for the base 44, the refraction index decreases by about 0.07 by applying a laser beam with a wavelength of 2 μm to 3 μm for 100 nsec as compared with that of nonirradiation. The region modified by the laser beam becomes the prism 45 (see FIG. 6B).

The irradiation with the laser beam causes ablation of the surface of the base 44 of the irradiated region to form the recess 45c at the end of the prism 45.

Then, a light-shielding-material layer 85 is formed on the surface of the base 44 and the prism 45 (see FIG. 6C). Here, the light-shielding-material layer 85 with a thickness of 0.5 μm, for example, is formed on the surface of the base 44 and the prism 45 by chemical vapor deposition or sputtering deposition. It is enough that the light-shielding-material layer 85 has a thickness to fill the recess 45c formed in the prism 45 by ablation.

The surfaces of the base 44 and the prism 45 are then polished by chemical mechanical polishing (CMP) (see FIG. 6D). Thus the region of the light-shielding-material layer 85 excluding the light-shielding material that fills the recess 45c of the prism 45 is removed to form the light-shielding layer 47. Thus, the condensing substrate 41 is formed. Then, the opposing electrode 42 and the alignment layer 43 are formed on the surface of the condensing substrate 41 to manufacture the opposing substrate 31.

Subsequently, the opposing substrate 31 and the separate TFT substrate 32 are placed one on top of another. Here, the opposing substrate 31 and the TFT substrate 32 are placed so that the prisms 45 agree with the boundary region of the pixel regions, and the liquid-crystal layer 34 is sealed between the opposing substrate 31 and the TFT substrate 32. Thus, the manufacture of the liquid crystal panel 15c is completed.

### Operation of Liquid Crystal Panel

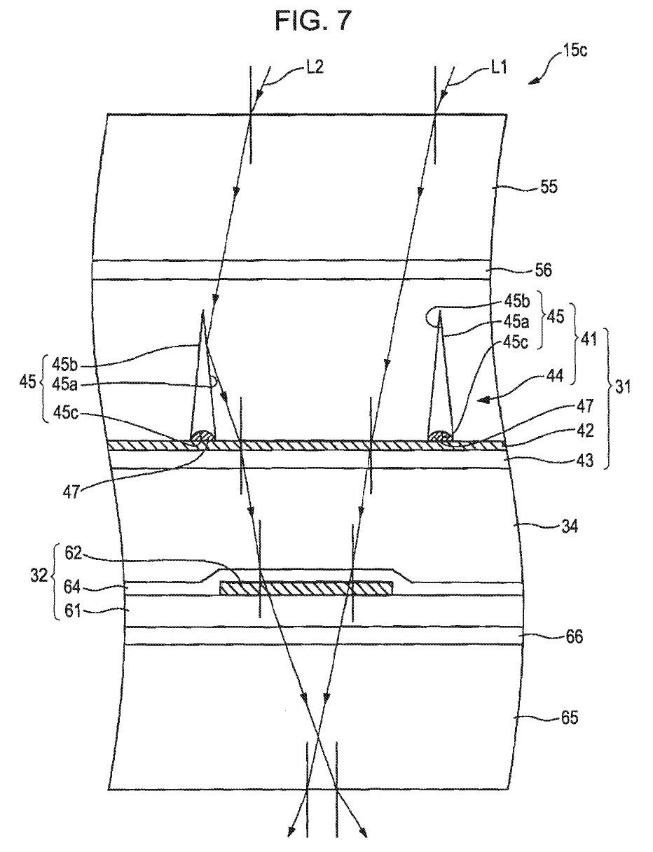

When light from the tight source 12 enters the spatial light modulator 15 with the above-described structure, the opposing substrate 31 of the liquid crystal panel 15c lets it out to the pixel region, as will be described below. FIG. 7 shows linear optical paths at interfaces with slight refraction difference for the purpose of simplification and illustration, although light beams are reflected or refracted by interfaces with refraction difference.

Referring to FIG. 7, a light beam L1 will be described which bypasses the prism 45 and directly enters the opening 46a of the prism group 46. The light beam L1 that has traveled in the air enters the condensing substrate 41 of the opposing substrate 31 through an incident surface The light beam L1 passes through the condensing substrate 41, and then passes through the opening 46a, the opposing electrode 42, the liquid-crystal layer 34, and the TFT substrate 32. The light beam L1 is modulated by the liquid-crystal layer 34 in accordance with an image signal supplied to the liquid crystal panel 15c, and passes through the adhesive layer 66 and the dustproof glass 65 to the exterior. The light beam L1 is projected to the screen 11 because the exit angle of the light beam L1 is smaller than the maximum angle that depends on the open area ratio NA of the projection lens of the projection system 20.

Referring to FIG. 7, a light beam L2 incident on the opening 46a of the prism group 46 through the prism 45 will be described. The light beam L2 incident on the base 44 advances in the base 44 into the slope 45a of the prism 45. The prism 45 is formed by modification of part of the base 44, whose refraction index is 0.07 smaller than that of the base 44. The light incident on the liquid crystal panel 15c of the projector 10 has an F-stop number of about 1.4 to 2.5 and a maximum incidence angle of about 11.7 to 19.7 degrees. Therefore, light beams with an incidence angle of up to about 20 degrees can be perfectly reflected by the slopes 45a and 45b of the prism 45.

Therefore, when the light beam L2 enters the slope 45a at a total reflection angle, it is reflected by the slope 45a to the opening 46a of the prism group 46 without entering the prism 45 through the slope 45a. The light beam L2 incident on the opening 46a then passes through the TFT substrate 32, the adhesive layer 66, and the dustproof glass 65, as in the above.

In contrast, when the incidence angle with respect to the slope 45a is smaller than the total reflection angle, part of the light beam L2 is refracted by the slope 45a into the prism 45 and then exits from the end face of the prism 45 adjacent to the liquid-crystal layer 34 toward the boundary region of the pixel regions; however, it is interrupted by the light-shielding layer 47 of the recess 45c of the prism 45, This prevents the boundary region of the pixel regions from being irradiated with the light incident on the prism 45,

The opposing substrate 31 thus orients the incident light to the pixel region. This prevents the TFT elements 63 disposed in the boundary region of the pixel regions from being irradiated with light, thereby preventing malfunction of the TFT elements 63 due to heat generated by absorption of light. The light beam L1 exits the liquid crystal panel 15c without a significant change in optical path. Also the light beam L2 does not change in exiting angle remarkably from the incidence angle because the prism 45 has no light condensing function, unlike microlenses. Accordingly, the modulated light exiting from the liquid crystal panel 15c also becomes substantially parallel light.

With the spatial light modulators 15 to 17, the condensing substrate 41, the method for manufacturing the spatial light modulators 15 to 17, and the projector 10, the laser-beam irradiated region of the base 44 is modified into the prisms 45. This decreases the time to manufacture the condensing substrate 41 as compared with prisms in the form of a groove of the base 44, thus simplifying the process of manufacturing the spatial light modulators 15 to 17.

The use of a laser beam allows the prisms 45 to be accurately formed in the base 44.

The use of an inorganic material such as glass for the condensing substrate 41 prevents the degradation of the condensing substrate 41 even if the liquid crystal panels 15c to 17c absorb light to generate high temperature. This increases the reliability and life of the condensing substrate 41.

The formation of the light-shielding layer 47 prevents the light incident on the prism 45 from exiting to the boundary region of the pixel regions. This prevents the malfunction of the TFT elements 63, the signal lines, and the scanning lines. Moreover, there is no need to provide cover glass between the condensing substrate 41 and the light-shielding layer 47 because the prisms 45 are integrated with the base 44, thus allowing the light-shielding layer 47 to be formed on the condensing substrate 41 with accuracy. Since the light-shielding layer 47 fills the recess 45c of the prism 45, the flatness of the condensing substrate 41 including the light-shielding layer 47 increases. This prevents the light exiting from the no prism region of the condensing substrate 41 which is in the vicinity of the rims of the prisms 45 from being interrupted by the light-shielding layer 47.

Furthermore, the formation of the opposing electrode 42 on the surface of the condensing substrate 41 can reduce the thickness of the liquid crystal panels 15c to 17c; moreover, this reduces the distance between the exiting side of the condensing substrate 41 and the liquid-crystal layer 34 in comparison with interposing a substrate between the opposing electrode 42 and the condensing substrate 41, thus ensuring that light exits from the condensing substrate 41 toward the pixel regions.

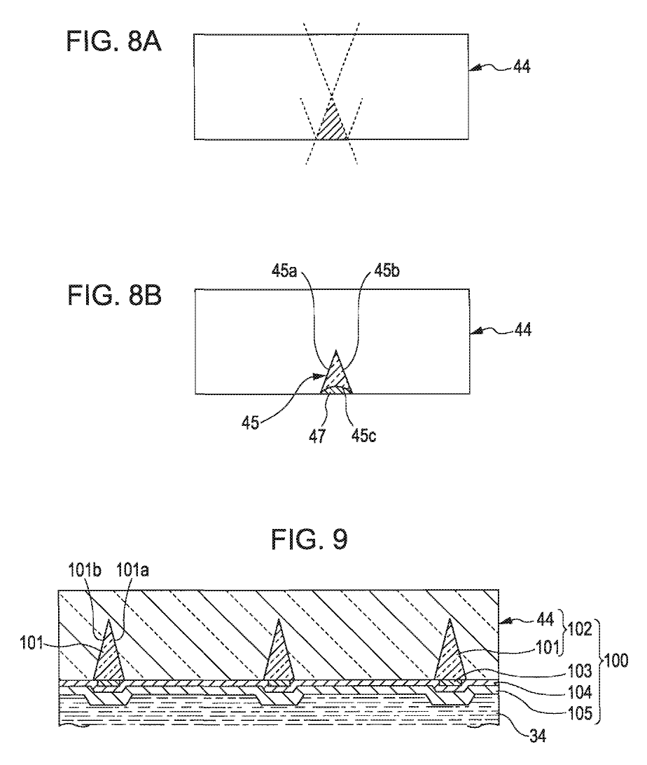

In this embodiment, the prisms 45 are provided on the laser-beam incident side of the base 44. However, the prism 45 may be provided on the opposite side of the laser-beam incident side, as shown in FIGS. 8A and 8B.

In the method for forming the prism 45, the light emitted from the light source is condensed on the side of the base 44 opposite to the laser-beam incident side, as shown in FIG. 8A. For the light source is used a femtosecond laser that is oscillated at a wavelength of about 400 nm to 1,000 nm and a frequency of about 100 mHz, which emits a laser beam to the base 44 at an intensity of 0.5 μJ to 5 μJ for an irradiation time of 100 fs.

When a laser beam is condensed at the position of the base 44 apart from the laser-beam incident surface, the laser beam is focused more than in the air in accordance with the refractivity of the base 44, so that the energy of the laser beam is concentrated in the region of the base 44 apart from the incident surface. Moreover, the laser beam incident on the base 44 is reflected by the opposite surface of the base 44 into return light. Therefore, the region where the laser beam and the return light agree with each other (the hatched region shown in FIG. 8A) has the highest energy density of the laser beam. Thus, the region where the laser beam and the return light agree with each other is melted by heat, which is then cooled to form the prism 45.

This way of forming the prisms 45 allows a desired triangular cross section prism 45 to be formed more accurately than forming the prism 45 on the laser-beam incident side of the base 44.

### Second Embodiment

An electrooptic device and a projector according to a second embodiment of the invention will be described. Since the embodiment is different in the structure of the condensing substrate from the first embodiment, this point will be principally described, wherein like components are given like reference numerals and their description will be omitted.

Referring to FIG. 9, an opposing substrate 100 of this embodiment includes a condensing substrate 102 including prisms 101 each having slopes 101a and 101b which are formed without ablation. Specifically, the end face of the prism 1101 adjacent to the liquid crystal layer 34 is flush with the base 44, and a light-shielding layer 103 is formed on the prism 101. Therefore, the light-shielding layer 103 projects from the plane of the condensing substrate 102 adjacent to the liquid-crystal layer 34.

An opposing electrode 104 and an alignment layer 105 project along the boundary region of the pixel regions because the light-shielding layer 103 projects from the condensing substrate 102.

The condensing substrate 102 with this structure, the liquid crystal panel having the same, and the projector also offer the same advantages as the first embodiment.

The invention is not limited to the foregoing embodiments and can be modified variously without departing from the spirit and scope of the invention.

For example, the cross section of the prism of the condensing substrate may not necessarily be an isosceles triangle but may be the following shape provided that it can condense Light into the pixel region of the liquid crystal panel with the prism.

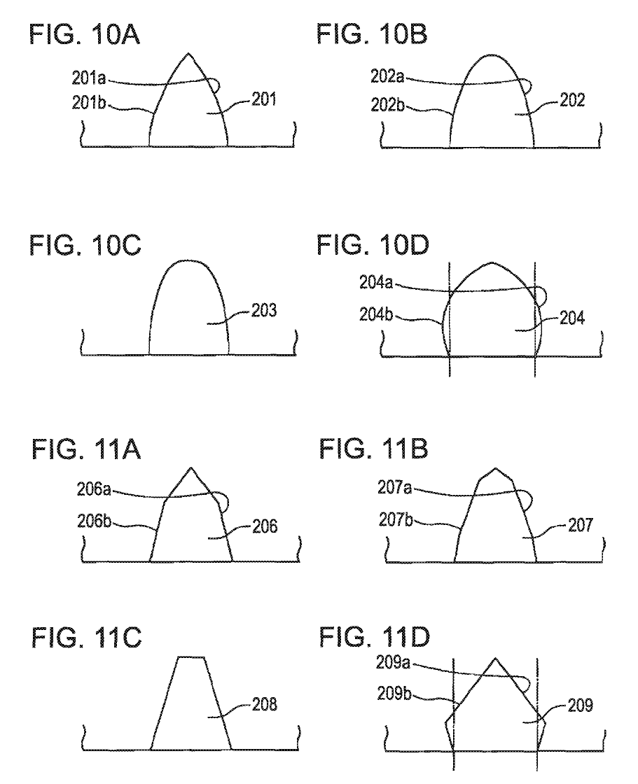

A groove 201 shown in FIG. 10A has curves 201a and 201b with a fixed radius of curvature of the cross section. Alternatively, it may be any of a prism 202 having curves 202a and 202b with an unfixed radius of curvature of the cross section as shown in FIG. 10B, a prism 203 whose end in cross section is a horizontal line as shown in FIG. 10C, and a prism 204 having curves 204a and 204b whose parts are located outside the perpendiculars extending along the thickness of the condensing substrate with respect to the end adjacent to the liquid crystal layer as shown in FIG. 10D.

A prism 206 shown in FIG. 11A has bent lines 206a and 206b that are bent at a portion in cross section. Alternatively, it may be any of a prism 207 having bent lines 207a and 207b that are bent at plural portions in cross section as shown in FIG. 11B, a prism 208 whose end in cross section is a horizontal line as shown in FIG. 11C, and a prism 209 having bent lines 209a and 209b whose parts are located outside the perpendiculars extending along the thickness of the condensing substrate with respect to the end adjacent to the liquid crystal layer as shown in FIG. 11D.

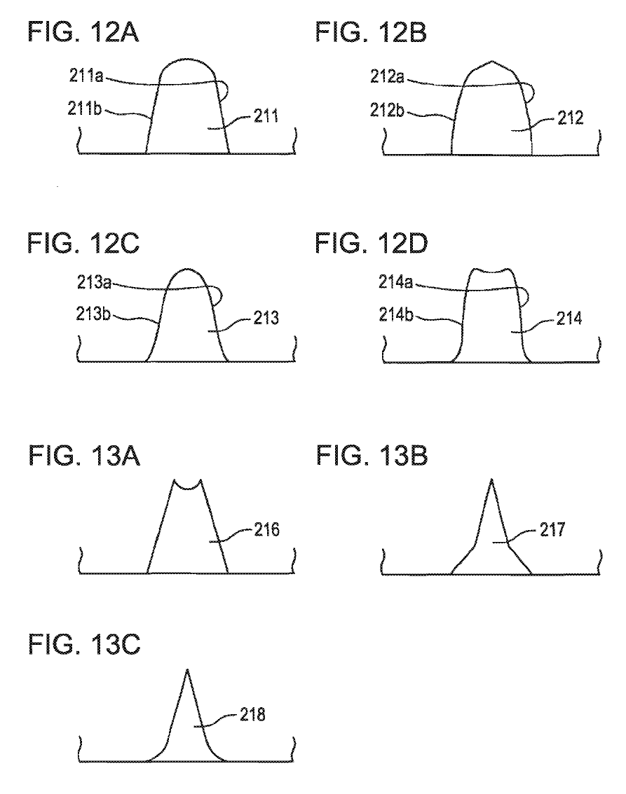

A prism 211 shown in FIG. 12A has curves 211a and 211b that are linear on the liquid-crystal layer side and are curved on the opposite side. Alternatively, it may be any of a prism 212 having curves 212a and 212b that are curved on the liquid-crystal layer side and are linear on the opposite side as shown in FIG. 12B, a prism 213 having continuous curves 213a and 213b in cross section as shown in FIG. 12C, and a prism 214 having continuous curves 214a and 214b as shown in FIG. 12D.

Alternatively, it may be prisms 216 to 218 shown in FIGS. 13A to 13C.

While the prisms of the condensing substrate are formed in the main body of the opposing substrate, the condensing substrate including the prisms may be disposed on the surface of the opposing substrate apart from the liquid-crystal layer.

While the light-shielding layer fills the recess of the prism, it may not necessarily fill the recess but may fill at least part of the recess.

While the condensing substrate has a light-shielding layer on the surface thereof; it may have no light-shielding layer provided that it can prevent light exiting from the condensing substrate to the boundary region of the pixel regions.

While the surface of the condensing substrate adjacent to the liquid-crystal layer is flat, it may not necessarily be flat provided that it can surely let out light from the condensing substrate to the pixel region.

The prism is formed by modification such that the substrate main body is irradiation with a laser beam, and the irradiated region absorbs the laser beam to generate heat. However the substrate main body may be irradiated with another energy wave such as ultraviolet rays provided that it is absorbed by the irradiated region to melt the irradiated region of the substrate main body by heat.

While the electrooptic device is a liquid crystal device, it is needless to say that the electrooptic device is not limited to the liquid crystal device: for example, devices having an electrooptical effect in which the refraction index of substances is changed by an electric field to change the transmissivity of light and devices that convert electric energy to optical energy, such as organic electroluminescent (EL) displays that use organic electroluminescence, inorganic electroluminescent (EL) displays that use inorganic electroluminescence, plasma displays that use plasma gas as an electrooptical material, electrophoretic displays (EPDs), and field emission displays (FEDs).

What is claimed is:

1. An electrooptic device comprising:
an electrooptic layer; and
a condensing substrate that (1) lets the light incident on the condensing substrate into the electrooptic layer and (2) includes a base and prisms,
the prisms being disposed along a boundary region of a plurality of pixel regions,
the prisms having a refraction index different from a refraction index of the base, and at least a portion of the prisms being located within the base.

2. The electrooptic device according to claim 1, the prisms being formed by modifying part of the precursor of the base.

3. The electrooptic device according to claim 1, the prisms and the base having the same composition.

4. The electrooptic device according to claim 1, the surface of the condensing substrate having a light-shielding layer along the boundary region of the pixel regions.

5. The electrooptic device according to claim 4, the surface of the prism adjacent to the electrooptic layer having a recess, the light-shielding layer being located within the recess.

6. The electrooptic device according to claim 1, the condensing substrate having an electrode disposed on the condensing substrate for driving the electrooptic layer.

7. The electrooptic device according to claim 1,
the prisms having prism end faces,
the base having a base end face, and
the prism end faces being flush with the base end face at a location adjacent to the electrooptic layer.

8. A projector comprising:
a housing;
the electrooptic device according to claim 1 disposed within the housing.

9. An electrooptic device comprising:
an electrooptic layer;
a condensing substrate (1) that lets the light incident on the condensing substrate into the electrooptic layer and (2) includes a base with a first refraction index and prisms with a second refraction index different from the first refraction index; and
a plurality of pixel electrodes,
the prisms being disposed substantially within a region between each of the pixel electrodes, and
at least a portion of the prisms being located within the base.

10. An electrooptic device comprising:
a first substrate;
a second substrate;
an electrooptic layer disposed between the first substrate and the second substrate; and
a condensing substrate including a base and prisms,
the condensing substrate being disposed between the first substrate and the electrooptic layer,
a side of the condensing substrate adjacent to the electrooptic layer or to the second substrate being capable of condensing light that enters from the first substrate into a region enclosed by the prisms and the base, and
at least a portion of the prisms being located within the base.

11. An electrooptic-device substrate that condenses light to a plurality of pixel regions of an electrooptic device, the substrate comprising:
a base; and
prisms formed along the boundary region of the pixel regions and reflecting incident light toward a plurality of pixel regions arrayed in a plane, the prisms being made of the same material as that of the base.

12. A method for manufacturing an electrooptic device including an electrooptic layer; and a condensing substrate disposed close to the incident side with respect to the electrooptic layer, the condensing substrate reflecting incident light to a plurality of pixel regions arrayed in a plane to let the light into the electrooptic layer, the method comprising:
forming the condensing substrate by modifying part of a base to form prisms, the prisms having a refraction index different from that of the base; and
disposing the condensing substrate close to the incident side with respect to the electrooptic layer so that the prisms correspond, in plan view, to regions between pixel regions.

13. The method for manufacturing an electrooptic device according to claim 12, the modification of the part of the base being melting the base and then cooling the base.

14. The method for manufacturing an electrooptic device according to claim 12, the modification of the part of the base being applying a laser beam to the base.

15. An electrooptic device comprising:
a condensing substrate with a first refractive index, the condensing substrate including a plurality of prisms with a second refractive index, the prisms being integrally formed within the condensing substrate in a grid-shaped pattern; and
a plurality of pixel electrodes,
the prisms not overlapping the pixel electrodes in plan view, and
the first refractive index being different from the second refractive index.

16. The electrooptic device according to claim 15, the prisms being made of the same material as the base.

17. The electrooptic device according to claim 15, further comprising signal lines and scanning lines disposed at a position corresponding to the prisms in plan view.

18. A method for manufacturing an electrooptic device comprising:
heating or irradiating a portion of a base until the base melts to form a plurality of prisms, the prisms having a refraction index different from a refraction index of the base;
forming a light-shielding material on the surface of the base and the prisms; and
removing a portion of the light-shielding material from the base so as to create a substantially flat surface between each one of the plurality of prisms.
